(19) United States
(12) Patent Application Publication
(10) Pub. No.: US 2021/0252546 A1
(43) Pub. Date: Aug. 19, 2021

(54) GRAPHICAL WATER MACHINE

(71) Applicant: Khaled Sulaiman Al Harbi, Al Madinah Al Munawwarah (SA)

(72) Inventor: Khaled Sulaiman Al Harbi, Al Madinah Al Munawwarah (SA)

(21) Appl. No.: 16/996,298

(22) Filed: Aug. 18, 2020

(30) Foreign Application Priority Data
Sep. 4, 2019 (SA) 119410014
Dec. 11, 2019 (SA) 119419288
May 10, 2020 (SA) 120410668

(51) Int. Cl. B05B 17/08; B05B 12/04

(52) U.S. Cl. CPC B05B 17/085; B05B 12/04

(57) ABSTRACT

A waterfall or fountain that has the capacity of printing images with water and a method for printing images by said water. The water inside such fountain is released out of nozzles in the form of parallel and regular lines of water.

### BACKGROUND

The present invention relates to water fountains that produce water in the form of images and words. The closest technical case to the present invention is granted patent no. 4679 by the Saudi Patent Office.

This application is a combination of the two applications 119410014 and 119410288, as registered at the Saudi Patent Office, along with other additional features.

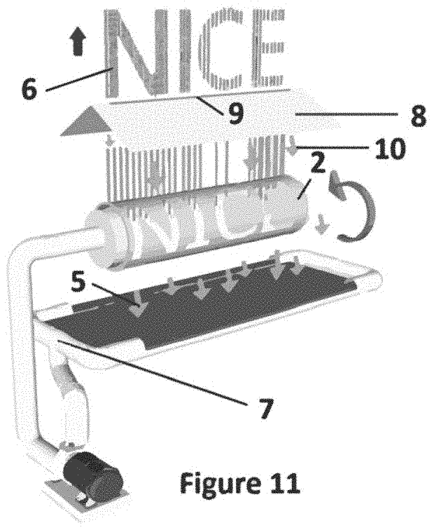

The prior technique is a fountain with a number of nozzles that produce water in the form of parallel lines of water with the same speed. A cylindrical body is surrounding this tube, wherein the images to be printed are cut from this cylindrical body, and the rotation of this cylindrical body prints images by water. (FIG. 11)

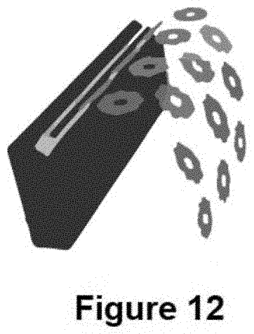

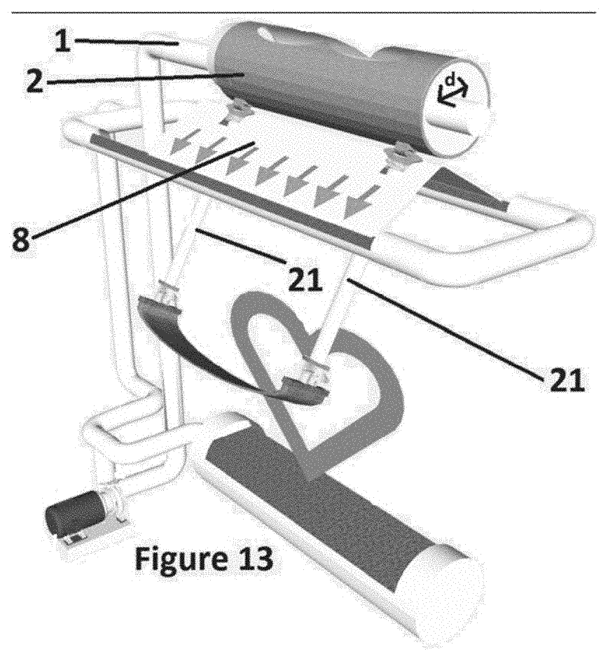

The water is produced by the fountain either:
(a) Top-Down in a vertical direction (FIG. 6), and in this case it can be used as a swing (FIG. 13)
(b) Top-Down in a curved or inclined direction
(c) Down-Top in a vertical direction (FIG. 11)
(d) Down-Top in a curved or inclined direction (FIG. 12)

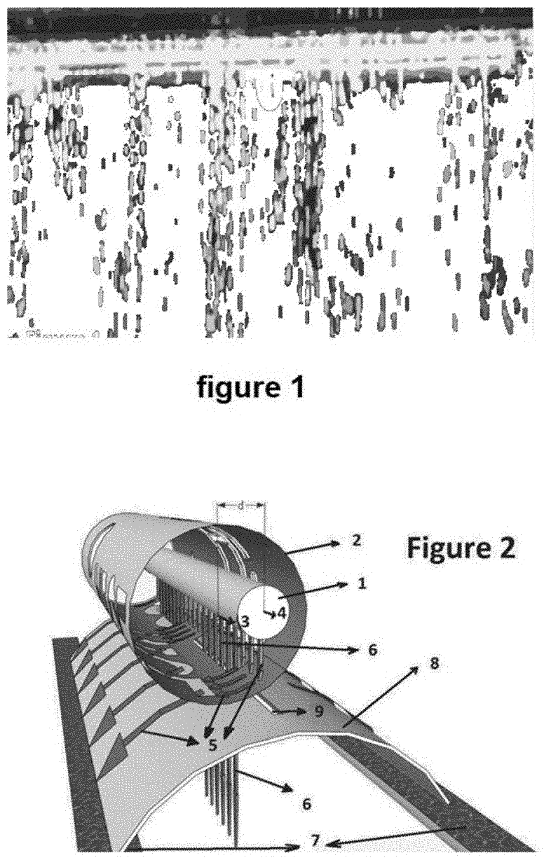

When the fountain is implemented in real world, we face a problem the wanted water come out of the fountain and as at the same time some of unwanted water comes out of the fountain also. As a result, the printed images become unclear, as shown in (FIG. 1)

Therefore, in Case (A), I added component (8), which allows the required water to pass through, while making the unwanted water (5) and (10) slide through it to the drainage systems (FIG. 2) (FIG. 6) (FIG. 13)

In case (A), the non-clarity of the image is more obvious. because When implementing this case in real world so that water falls from top to down, the unwanted water will keep coming out of the fountain because of Earth's gravity (FIG. 1)

To elaborate the problem, we will classify the water exiting the fountain into two types:

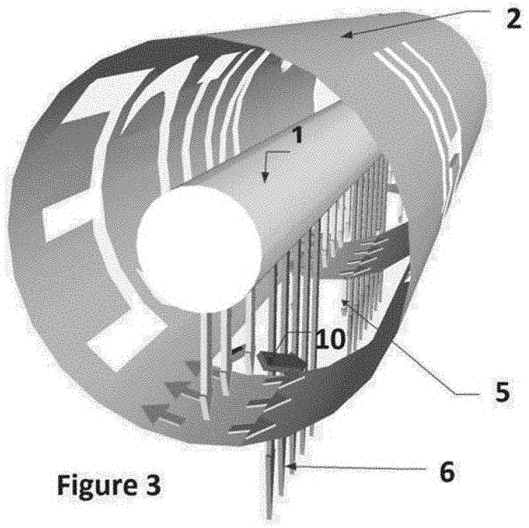

Type 1: the water we like to appear (6) (represents the printed image) (FIG. 3)

Type 2: the water we do not like to appear, which is (5) and (10), (FIG. 3)

Accordingly, we would like to produce the water we like to appear (6) from the cylindrical body, as well as to dispense the unwanted water (5) and (10); but in real application, both types of water will exit, which results in deforming the image to be printed and causes it to be unclear.

### FEATURES OF THE INVENTION

The present invention provides a solution for the problem of deformation of images produced by the fountain, by installing a discharge and filter system. The present invention also marks new features which contribute to improving the produced images.

### BRIEF DESCRIPTION

In view of the above, the prior technique of fountain does not produce clear images; thus, I added component (8) to filter water in cases (a, b, c, d). In addition, the quality of printed images can be improved by inclining the water exit as in cases (b, d).

In case (a), there is more none-clarity of the printed image. To understand the reason of none-clarity, I would like to look at the details of (FIG. 3) and imagine the existing components. We have a tube (1), from which parallel lines of water exit. A cylindrical body (2) surrounds the center of the same and rotates around it. In this cylindrical body, there are many gaps that represent the cut images. Upon rotation of this cylindrical body, some water lines (6) exit the gaps in the cylindrical body which rotates while some water lines hit the edges of the gaps (10), which causes the water to comes out in an inclined direction, while the rest of water (5) will remain at the bottom of the cylindrical body (2) and comes out through the gaps randomly. As a result, they exit in the form of random drops associated with the image to be printed (6). This causes none-clarity of image produced by the fountain. Therefore, I found a solution to end this problem by providing a method for discharging the unwanted water (5) and (10). (FIG. 2)

The invented discharge system for fountain in case (a), which contributes to preventing appearance of the unwanted water, depends on a main addition.

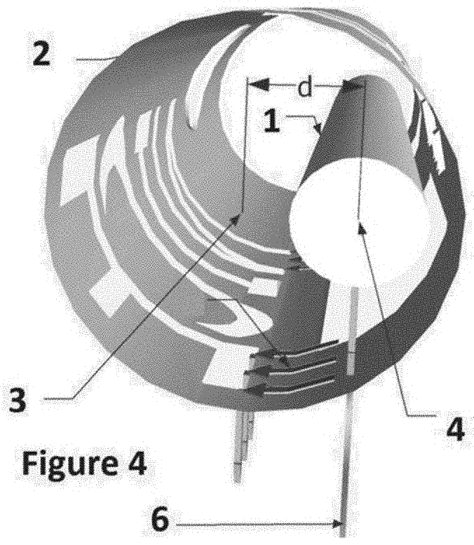

This addition is represented in adding distance din case (a), between the center of circle of the cylindrical body (3) and the center of circle of the tube (4). (FIG. 4)

With this addition, the problem is not completely solved; as we see in (FIG. 4), the unwanted water (5) is still gathering below the cylindrical body (2) and infiltrate through the gaps. Here comes the importance of the second addition I made and it is useful for all cases (a, b, c, d)

The second addition: a curved or inclined body (8) exists outside the cylindrical body (2) allows the water we like to appear (6) to go through the such body, while making the unwanted water (5) and (10) slide through it to the drainage systems (7) (FIG. 2) (FIG. 6) (FIG. 13)

### BRIEF DESCRIPTION OF THE FIGURES:

FIG. (1): a real picture of a pilot model which I tested. The figure shows unwanted water (5) and (10), wherein I put circles around them.

FIG. (2): this picture represents the mechanism in cases (a,b)

FIG. (3): a picture that shows prior technique mechanism with which the fountain works.

FIG. (4): to show the invention in case (a) after adding distance d between the center of tube and the center of cylindrical body.

FIG. (5): to show the method of cutting images with hollow borders, as well as to how the cylindrical body cuts without inclined edges.

FIG. (6): a complete picture of the invention which shows some of the main components

FIG. (7): a picture that shows we can add a row pr more of nozzles that water come out of them

FIG. (8): a side picture of the invention which shows that in case (A,B) we can add an inclined or curved body (18) inside the cylindrical body, which contributes to preventing unwanted water from appearing, that are producing during the rotation of the cylindrical body (2) so that it slides through it to component (8) which also allow the water to slide through it to the drainage systems (7)

FIG. (9): a picture shows that we can add barriers around the cut image from the cylindrical body to prevent water from deforming the image.

FIG. (10): An image showing that we can add one or more wheels to rotate the cylindrical body by taking advantage of the force of applied water

FIG. (11): a picture which shows the fountain when water falls from top-down as in case (c).

FIG. (12): a picture which shows the fountain when water come out in a curved direction from down-top as in case (d).

FIG. (13): a picture which show the possibility of using the fountain in case (a) as a swing

FIG. (14): a picture which shows that we can add an upper vessel hit by water in case (c) and (d) and then such water is discharged.

FIG. (15): a picture which show the working principle of the fountain operates in case passing a flat body.

FIG. (16): a picture showing the fountain.

### REFERENCE NUMBERS

(1): Tube or the component from which parallel lines of water come out at the same speed
(2): Cylindrical body which comprises the cut (sheared) image
(3): Center of circle of the cylindrical body (2)
(4): Center of circle of the tube or the component (1)
(5): Gathered unwanted water
(6): Wanted water which represents printed image with water which we like to appear
(7): Discharge system
(8): Component exists outside the cylindrical body (2) and allows the required water to pass through it, while let the unwanted water to slide to the drainage system
(9): One or more gaps in the can be added in the component (8) in cases (a,b) to enable the water we like (printed image) to pass through
(10): Inclined and volatile water that are not desired to appear due to its collision with edges of the sheared image
(11): Water pump
(12): Water pump
(13): Motor
(14): Controller
(15): Light
(16): Air blower
(17): Water suction device
(18): an inclined or curved body (18) can be added inside the cylindrical body, which contributes to preventing unwanted water from appearing, that are producing during the rotation of the cylindrical body (2) so that it slides through it to component (8) which also allow the water to slide through it to the drainage systems (7)
(19): Barriers we can add at edges of the cut images
(20): Water wheel or pendulum
(21): Two arms of the swing

### DETAILED DESCRIPTION:

The present invention is a developed version of the one granted patent no. 4679 by the Saudi Patent Office.

The present invention mostly comprises the same components of any conventional fountain.

In this application, I showed the cases of the fountain (a, b, c and d) and how to solve the problems of each case, as shown below:

Water exits from the fountain:
(a) Top-Down in a vertical direction (FIG. 6), and in this case it can be used as a swing (FIG. 13)
(b) Top-Down in a curved or inclined direction
(c) Down-Top in a vertical direction (FIG. 11)
(d) Down-Top in a curved or inclined direction (FIG. 12)

There are many additions to these four cases that may be classified into two types:

Type 1: Additions that can be applied to all cases a, b, c and d

Type 2: Additions to certain cases

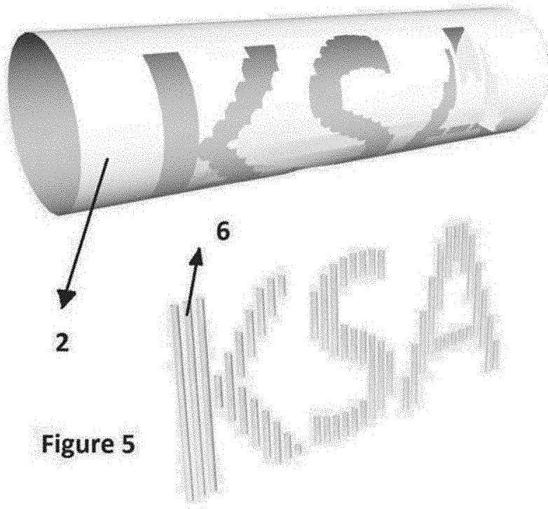

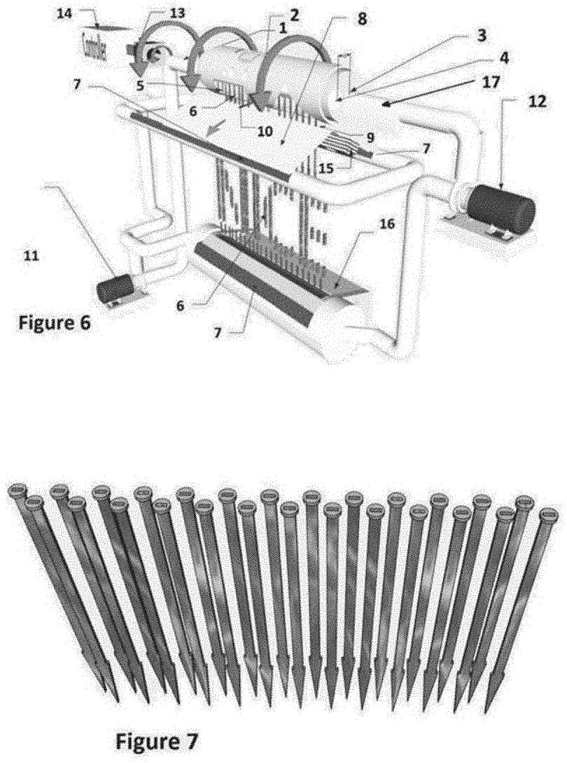

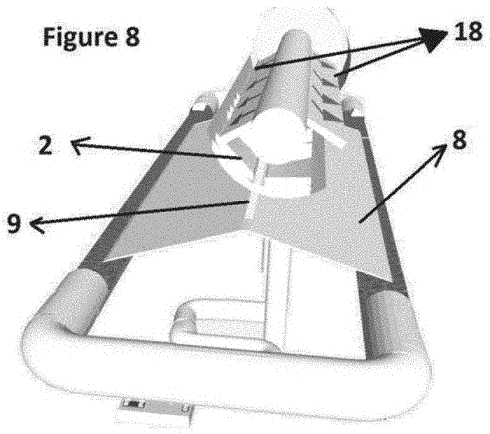

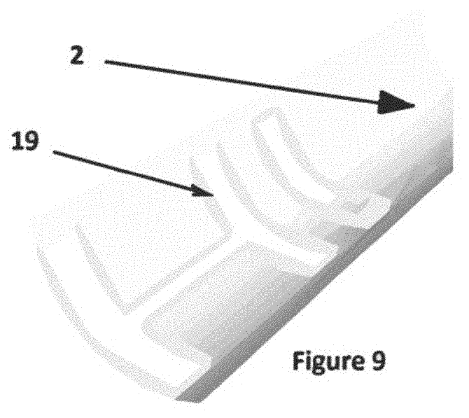

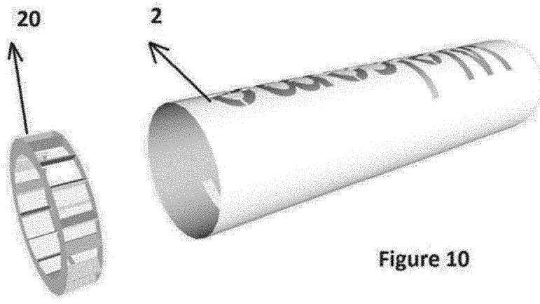

Additions of type 1:
1—A component (8) which located outside the cylindrical body (2) and it has one or two of curved or inclined sides. (This component allows the printed images to pass through its gap/gaps, only in cases a and b), while making the unwanted water (5) and (10) slide to the drainage systems for all the cases (FIG. 2) (FIG. 6) (FIG. 13) (FIG. 11)
2—One or more of water wheels (pendulums) can be added to utilize the driving force of the water in order to rotate the cylindrical body (2) by adding one or more wheels (20) to be fixed on the cylindrical body (2). we can also add a water source that we can control its driving force can be directed, to push water toward the wheel, which leads to its rotation and, as a result, the cylindrical body will rotate. (FIG. 10)
3—A new mechanism can be added to cut the patterns that have completely empty borders which cannot be cut from the cylindrical body (2). For example, if we cut letter A as is on the cylindrical body (2), the small triangle of the letter A would fall. also, in case of the letter O, the inner circle would fall. I solved this problem by connecting these patterns to the cylindrical body (2) through paths which do not intersect with water paths (6). (FIG. 5)
4—The cylindrical body (2) can be represented with a cylindrical structure can be rotated so that separated moulds, containing the cut images that can be install on this structure, are mounted to facilitate changing images every time. (FIG. 10)
5—A method can be added to prevent paths of water lines (6) from hitting the inclined edges of the cylindrical body (2) by cutting (shearing) the images inside the cylindrical body (2) in a way which ensures that edges of the printed image inside the cylindrical body are completely parallel to the cylindrical body, wherein when these edges hit water lines (6) we guarantee that all these edges will cut all water lines completely and vertically without causing water to volatile in random directions (FIG. 5)
6—A controller (14) can be added to control the speed of the electrical motor (13), which rotates the cylindrical body (2) if we wish to rotate the cylindrical body (2) through a motor. (FIG. 6)
7—Barriers (19) can be added at the edges of the cut images that exist in the cylindrical body, wherein water is gathered inside barriers to prevent its exit with the printed images, this addition will be useful only if the barriers were inclined wherein water do not hit the barriers. (FIG. 9)
8—Programmable controller can be added to control lighting (15). (FIG. 6)
9—To avoid water gathering below the cylindrical body (2), a tool working like a sweeper can be added to proceed with water suction (17) to be connected to a pump (12) and to be located inside the cylindrical body to proceed with suction of volatile or gathered water and push it toward the discharge system (7). (FIG. 6)
10—For more clarification of the images produced from waterfall, one or more rows of nozzles can be added to eject water. (FIG. 7)
11—To reduce the speed of water that are exiting from the fountain, an air blower (16) can be added to blow air in an opposite direction of the water ejected from the fountain, in order to reduce the speed of water, which contributes to making it clearer to those who watch the fountain. (FIG. 6)
12—A component with two curved or inclined surfaces (18) can be added, to be located inside the cylindrical body, to enable the unwanted volatile water which gathered during rotation of the cylindrical body to slide through, and then unwanted water exit through holes of the sheared images in the cylindrical body (2), to fall on the inclined component (8), as in cases (a and b), or it falls directly into discharging system as in cases (c and d). This component aims to reduce the gathering of water inside the cylindrical body (2), as well as to attempt displacing the unwanted gathered water away from the bottom of the middle of the cylindrical body, wherein water exits from both of upper sides of the holes that exist in the cylindrical bod (2) instead of the bottom of the middle of the cylindrical body (in cases a and b), in order not to deform the printed image (FIG. 8).

Additions of type 2:
13—Furthermore, there is an addition for case (a), which can be applied also to case (b), which is distance d between the center of circle of the tube (4) and the center of circle of the cylindrical body (3), wherein d<0. The aim of adding this distance is to enable the wanted water (printed images) (6) to exit from the cylindrical body (2) from an upper side, and because volatile water usually gathers in the middle of the lowest point inside the cylindrical body (2) and as a result of that leads to deform the printed image, and to avoid this problem, I added distance d so that water exit from an upper side, a little bit distant from the middle, and close to one of the two sides, wherein the gathered unwanted water (5 and 10) will fall to the component (8) instead of intersecting with the printed images. (FIG. 4) (FIG. 2)
14—The fountain in case (a) can be turned into a swing by adding two arms (21) connected to the cylindrical body (2), wherein the cylindrical body rotates according to the movement of swing arms, so that when the rider of the swing swings, water falls vertically toward ground. but when the rider is in the middle, under the swing, water does not fall on him (FIG. 13)
15—a component that works as a container or as a box to cover all or some parts of a fountain can be added so that the this component will allow to water that represents the printed message (6) to pass through and in same time this component hides the unwanted parts from appearing and also this component prevents the unwanted water from appearing to be drained through the drainage system, and can This addition applies to all cases (A, B, C, and D) and also can be added to the swing. FIG. 12

What is claimed is:

1. A water fountain (waterfall/curtain) like any ordinary fountain, from which water or any other liquid exits, in the form of parallel, close and regular (lines/paths) have the same speed. The fountain is distinguished by providing a method for printing images (patterns/words) with this water by passing the image to be printed through water paths, wherein the image is sheared either on a flat body as in (FIG. 15) or a cylindrical body, and the direction of the water exit may be one of the following:
(a) Top-Down in a vertical direction (FIG. 6)
(b) Top-Down in a curved or inclined direction
(c) Down-Top in a vertical direction (FIG. 11)
(d) Down-Top in a curved or an inclined direction. (FIG. 12)

2. According to claim 1, a component outside the cylindrical body can be added, this component contains one or more of curved or an inclined sides , the aim of this component to allow the unwanted water to slide through it to discharging system In cases of water falling Top-Down, there are one or more of gaps can be added to this component, these (gap/gaps) (9) allows the wanted water (printed images) to pass through (FIG. 2) (FIG. 11)

3. According to claim 1, one or more of water wheels (pendulums) can be added to utilize the driving force of the water in order to rotate the cylindrical body (2) by adding one or more wheels (20) to be fixed on the cylindrical body (2). we can also add a water source with controllable driving force, to push water toward the wheel, which leads to its rotation and, as a result, the cylindrical body will rotate. (FIG. 10)

4. According to claim 1, images with hollow borders such as the letter A can be cut inside the cylindrical body, by connecting them with paths connected to the cylindrical body which do not intersect with paths of water lines.

5. According to claim 1, the cylindrical body (2) can be represented with a cylindrical structure can be rotated so that separated moulds, containing the cut images that can be install on this structure, are mounted to facilitate changing images every time. (FIG. 10)

6. According to claim 1, A method can be added to prevent paths of water lines (6) from hitting the inclined edges of the cylindrical body (2) by cutting (shearing) the images inside the cylindrical body (2) in a way which ensures that edges of the printed image inside the cylindrical body are completely parallel to the cylindrical body, wherein when these edges hit water lines (6) we guarantee that all these edges will cut all water lines completely and vertically without causing water to volatile in random directions (FIG. 5)

7. According to claim 1, one or more of electrical engines (motors) can be added to rotate the cylindrical body, and control system can be added to control the speed of the electrical engine.

8. According to claim 1, Barriers (19) can be added at the edges of the cut images that exist in the cylindrical body, wherein water is gathered inside barriers to prevent its exit with the printed images, this addition will be useful only if the barriers were inclined wherein water do not hit the barriers. (FIG. 9)

9. According to claim 1, a programmable lighting system can be added

10. According to claim 1, to avoid water that may gather below the cylindrical body (2), a tool can be added to operate like a sweeper to suck water (17), such tool is connected to a pump (12) and located inside the cylindrical body, in parallel, so that it sucks the volatile or gathered water and draws it toward the discharge system. (FIG. 6)

11. According to claim 1, to increase clarity of the images launched by the waterfall, one or more rows of nozzles, can be added. (FIG. 7)

12. According to claim 1, pumping system (16) to blow air in a direction opposite to the water flow exiting the fountain can be added, to reduce water speed, which would slow down the time of its passage, which contributes to making it clearer to those who watch the fountain. (FIG. 6)

13. According to claim 1, a component with two curved or inclined surfaces (18) can be added, to be located inside the cylindrical body, to enable the unwanted volatile water [(5) and (10)] that gathering during rotation of the cylindrical body to slide through it, and then unwanted water exit through holes of the sheared images (cut images) in the cylindrical body (2), to fall on the inclined component (8), as in cases (a and b), or it falls directly into discharging system as in cases (c and d). This component aims to reduce the gathering of water inside the cylindrical body (2), as well as to attempt displacing the unwanted gathered water away from the bottom of the middle of the cylindrical body, wherein water exits from both of upper sides of the holes that exist in the cylindrical bod (2) instead of the bottom of the middle of the cylindrical body (in cases a and b), in order not to deform the printed image (FIG. 8).

14. There is a particular addition for case (a) which can be applied also to case (b), which is the distance d between the center of circle of the pipe (4) and the center of circle of the cylindrical body (3), wherein d<0. The aim of adding this distance is to enable the wanted water (printed images) (6) to exit the cylindrical body from an upper side, and because volatile unwanted water usually gathers in the middle of the lowest point inside the cylindrical body (2), and to avoid this problem, I added distance d so that the water exits from an upper side a little bit distant from the middle, and to get closer to one of the two sides, so that the gathered unwanted water (5 and 10) will fall to the component (8) instead of intersecting and hitting with the printed images (6). (FIG. 4) (FIG. 2)

15. The fountain in case (a) can be turned into a swing by adding two arms (21) connected to the cylindrical body (2), wherein the cylindrical body rotates according to the movement of swing arms, so that when the rider of the swing swings, water falls vertically toward ground. but when the rider is in the middle, under the swing, water does not fall on him (FIG. 13)

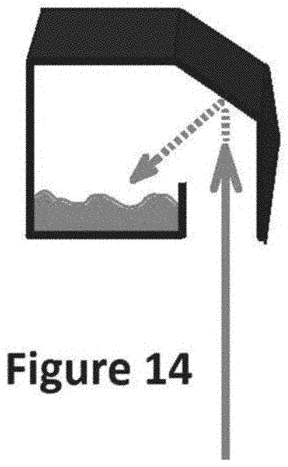

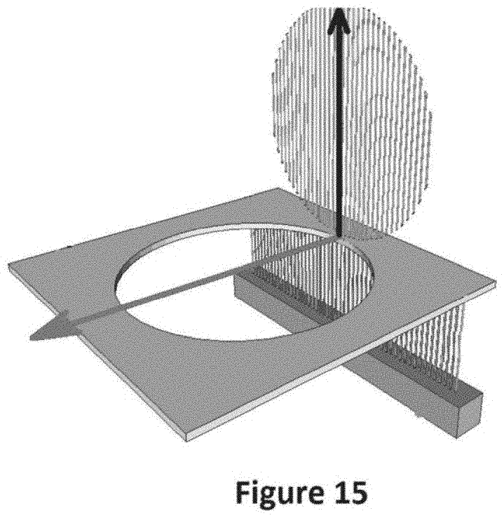

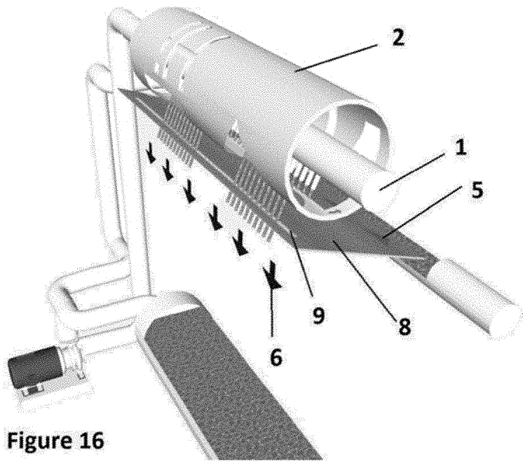

16. a method for gathering the water ejected from the fountain in cases (c) and (d) can be added, wherein a vessel is located on top, when water hits its ceiling will turns back inside this vessel to be discharged. (FIG. 14)

17. a component that works as a container or as a box to cover all or some parts of a fountain can be added so that the this component will allow to water that represents the printed message (6) to pass through and in same time this component hides the unwanted parts from appearing and also this component prevents the unwanted water from appearing to be drained through the drainage system, and can This addition applies to all cases (A, B, C, and D) and also can be added to the swing. FIG. 12
